(19) United States
(12) Patent Application Publication
(10) Pub. No.: US 2016/0160982 A1
(43) Pub. Date: Jun. 9, 2016

(54) HYDRAULIC CONTROL UNIT HAVING INTERFACE PLATE DISPOSED BETWEEN HOUSING AND PUMP

(71) Applicant: Eaton Corporation, Cleveland, OH (US)

(72) Inventors: Andrew N. Edler, Homer, MI (US); Daniel P. Fisher, Coldwater, MI (US); John A. Grogg, Laotto, IN (US)

(21) Appl. No.: 15/044,704

(22) Filed: Feb. 16, 2016

Related U.S. Application Data
(63) Continuation of application No. PCT/US2014/038886, filed on May 21, 2014.
Application No. PCT/US2014/038886 is a continuation of application No. PCT/US2014/038365, filed on May 16, 2014.
(60) Provisional application No. 61/868,800, filed on Aug. 22, 2013.
(60) Provisional application No. 61/868,784, filed on Aug. 22, 2013.

(51) Int. Cl. F16H 48/32; F04C 15/00; F04C 2/10

(52) U.S. Cl. CPC F16H 48/32; F04C 2/102; F04C 15/008; F04C 15/0015

(57) ABSTRACT

A hydraulic control unit that delivers hydraulic fluid to a limited slip differential constructed in accordance to the present disclosure can include a hydraulic control unit housing, a motor, a gerotor gear assembly and an interface plate. The hydraulic control unit housing can have a housing mounting surface. The motor can include an output shaft and a motor mounting plate that has a motor mounting surface. The gerotor gear assembly can include an inner and outer gerotor gear. The outer gerotor gear can be formed of a first material having a first coefficient of expansion. The interface plate can be mounted between the housing mounting surface and the motor mounting surface. The interface plate can receive the outer gerotor gear in an interference fit. The interface plate is formed of a second material having a second coefficient of expansion that is substantially equivalent to the first coefficient of expansion.

### CROSS-REFERENCE TO RELATED APPLICATIONS

This application is a continuation of International Application Nos. PCT/US2014/038886 filed on May 21, 2014 and PCT/US2014/038365 filed on May 16, 2014, which claim priority to U.S. Provisional Application Nos. 61/868,800, filed Aug. 22, 2013 and 61/868,784 filed on Aug. 22, 2013, which are incorporated by reference in their entirety as if set forth herein.

### FIELD

The present disclosure relates generally to limited slip differentials and more particularly to a hydraulic control unit that delivers hydraulic fluid to a limited slip differential.

### BACKGROUND

Differentials are provided on vehicles to permit an outer drive wheel to rotate faster than an inner drive wheel during cornering as both drive wheels continue to receive power from the engine. While differentials are useful in cornering, they can allow vehicles to lose traction, for example, in snow or mud or other slick mediums. If either of the drive wheels loses traction, it will spin at a high rate of speed and the other wheel may not spin at all. To overcome this situation, limited-slip differentials were developed to shift power from the drive wheel that has lost traction and is spinning to the drive wheel that is not spinning.

Electronically-controlled, limited-slip differentials can include a hydraulically-actuated clutch to limit differential rotation between output shafts of the differential. In some configurations a hydraulic delivery device may be located remote from the differential.

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure.

### SUMMARY

A hydraulic control unit that delivers hydraulic fluid to a limited slip differential constructed in accordance to the present disclosure can include a hydraulic control unit housing, a motor, a gerotor gear assembly and an interface plate. The hydraulic control unit housing can have a housing mounting surface that defines a fluid inlet port therein. The motor can include an output shaft and a motor mounting plate that has a motor mounting surface. The gerotor gear assembly can include an inner gerotor gear and an outer gerotor gear. The outer gerotor gear can be formed of a first material having a first coefficient of expansion. The inner gerotor gear can be coupled for rotation with the output shaft. The interface plate can be mounted between the housing mounting surface and the motor mounting surface. The interface plate can have an inner diameter that defines an opening that receives the outer gerotor gear in an interference fit. The interface plate is formed of a second material having a second coefficient of expansion. The first and second coefficients of expansion are substantially equivalent.

According to additional features, the interface plate and the outer gerotor gear can be formed of the same material. The interface plate can be formed of steel. The outer gerotor gear can be formed of steel. In other configurations, the interface plate can be formed of powdered metal. The outer gerotor gear can be formed of powdered metal. The interface plate can have a plurality of radially extending plate mounting ears that define a corresponding plurality of plate mounting apertures.

According to other features, the motor mounting plate can have a plurality of radially extending motor mounting apertures. The hydraulic control unit housing can define a plurality of housing mounting apertures. The plurality of interface plate mounting apertures, the plurality of motor mounting apertures and the plurality of housing mounting apertures can cooperatively align to receive a plurality of fasteners that secure the motor, the interface plate and the hydraulic control unit housing together. The hydraulic control unit housing can further comprise an integrally formed housing manifold portion that defines a fluid port configured to at least partially communicate hydraulic fluid between the accumulator housing portion and the limited slip differential.

According to other features, the hydraulic control unit can further comprise a pair of locating posts. The hydraulic control unit housing can define a first pair of locating post apertures. The interface plate can define a second pair of locating post apertures. The motor mounting plate can define a third pair of locating post apertures. The pair of locating posts can be received by the first, second and third locating post apertures to inhibit relative rotation of the hydraulic control unit housing, interface plate and motor.

According to still other features, the motor mounting plate can define a radial groove at a location radially outwardly of the output shaft. The radial groove can receive an o-ring that sealingly engages the interface plate. The hydraulic control unit housing can be unitary and further comprise an accumulator housing portion and a sump housing portion.

A hydraulic control unit that delivers hydraulic fluid to a limited slip differential and constructed in accordance to other features of the present disclosure can include a hydraulic control unit housing, a motor, a gerotor gear assembly and an interface plate. The hydraulic control unit housing can have a housing mounting surface. The motor can have an output shaft and a motor mounting plate that has a motor mounting surface. The gerotor gear assembly can include an inner gerotor gear and an outer gerotor gear. The outer gerotor gear can be formed of steel. The inner gerotor gear can be coupled for rotation with the output shaft. The interface plate can be mounted between the housing mounting surface and the motor mounting surface. The interface plate can be engaged to the outer gerotor gear in a fixed relationship. The interface plate can be formed of steel. The steel outer gerotor gear and the steel interface plate can be configured to thermally expand at a substantially similar rate.

According to other features, the interface plate can have an inner diameter that defines an opening that receives the outer gerotor gear in an interference fit. In one configuration, the outer gerotor gear and the interface plate can be formed of powdered metal. The interface plate can have a plurality of radially extending plate mounting ears that define a corresponding plurality of plate mounting apertures. The motor mounting plate can have a plurality of radially extending motor mounting apertures. The hydraulic control unit housing can define a plurality of housing mounting apertures. The plurality of interface plate mounting apertures, the plurality of motor mounting apertures and the plurality of housing mounting apertures can cooperatively align to receive a plurality of fasteners that secure the motor, interface plate and hydraulic control unit housing together.

A hydraulic control unit that delivers hydraulic fluid to a limited slip differential according to other features of the instant disclosure can include a hydraulic control unit housing, a motor, a gerotor gear assembly and an interface plate. The hydraulic control unit housing can have a housing mounting surface. The motor can have an output shaft and a motor mounting plate that has a motor mounting surface. The gerotor gear assembly can include an inner gerotor gear and an outer gerotor gear. The outer gerotor gear can be formed of powdered metal. The inner gerotor gear can be coupled for rotation with the output shaft. The interface plate can be mounted between the housing mounting surface and the motor mouting surface. The interface plate can be engaged to the outer gerotor gear in a fixed relationship. The interface plate can be formed of powdered metal. The powdered metal outer gerotor gear and the powdered metal interface plate are configured to thermally expand at a substantially similar rate.

In other configurations, the outer gerotor gear and the interface plate are formed of steel. The interface plate can have a plurality of radially extending plate mounting ears that define a corresponding plurality of plate mounting apertures. The motor mounting plate can have a plurality of radially extending motor mounting apertures. The hydraulic control unit housing can define a plurality of housing mounting apertures. The plurality of interface plate mounting apertures, the plurality of motor mounting apertures and the plurality of housing mounting apertures can cooperatively align to receive a plurality of fasteners that secure the motor, interface plate and hydraulic control unit housing together.

A hydraulic control unit that delivers hydraulic fluid to a limited slip differential according to the present disclosure can include a unitary hydraulic control unit housing. The unitary hydraulic control unit housing can include a sump housing portion, an accumulator housing portion and a housing manifold portion. The pump housing portion can define a sump chamber. The accumulator housing portion can define an accumulator chamber. The housing manifold portion can have a fluid passage that fluidly connects the sump chamber and the accumulator chamber.

According to additional features, the sump chamber can define a longitudinal sump chamber axis. The accumulator chamber can define a longitudinal accumulator chamber axis. The longitudinal sump chamber axis and the longitudinal accumulator chamber axis can be parallel. A clutch piston pressure sensor can be coupled to the unitary hydraulic control unit housing. The clutch piston pressure sensor can be configured to measure a clutch piston pressure of the limited slip differential. A sump fluid temperature sensor can be coupled to the unitary hydraulic control unit housing. The sump fluid temperature sensor can be configured to measure a temperature of fluid in the sump chamber.

According to further features, an accumulator pressure sensor can be coupled to the unitary hydraulic control unit housing. The accumulator pressure sensor can be configured to measure a pressure in the accumulator chamber. A three-way proportional regulating valve can be coupled to the unitary hydraulic control unit housing. The three-way proportional regulating valve can be configured to regulate fluid pressure within the unitary hydraulic control unit housing.

According to still additional features the hydraulic control unit can further comprise a motor and a gerotor gear assembly. The motor can have an output shaft. The motor can be coupled to the unitary hydraulic control unit housing. The gerotor gear assembly can include an inner gerotor gear and an outer gerotor gear. The inner gerotor gear can be coupled for rotation with the output shaft. The motor can define a longitudinal motor axis. The longitudinal motor axis can be parallel to the longitudinal accumulator axis.

According to other features the longitudinal clutch piston pressure sensor axis, the longitudinal sump fluid temperature sensor axis and the longitudinal clutch piston pressure sensor axis are all parallel relative to each other and to the longitudinal motor axis. A sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. A piston can be slidably disposed in the accumulator chamber. An accumulator plug can be sealingly disposed in a second opening defined in the unitary hydraulic control unit housing at an end of the accumulator housing portion. The unitary hydraulic control unit housing can define a second snap ring groove at the second opening configured to receive a second snap ring that captures the accumulator plug in the accumulator housing portion.

A hydraulic control unit that delivers hydraulic fluid to a limited slip differential constructed in accordance to additional features can include a unitary hydraulic control unit housing, a motor and a gerotor gear assembly. The unitary hydraulic control unit housing can include a sump housing portion, an accumulator housing portion and a housing manifold portion. The sump housing portion can define a sump chamber. The accumulator housing portion can define an accumulator chamber. The housing manifold portion can have a fluid passage that fluidly connects the sump chamber and the accumulator chamber. The motor can have an output shaft. The motor can be coupled to the unitary hydraulic control unit housing. The gerotor gear assembly can include an inner gerotor gear and an outer gerotor gear. The inner gerotor gear can be coupled for rotation with the output shaft.

According to additional features, the motor can define a longitudinal motor axis. The longitudinal motor axis can be parallel to the longitudinal accumulator axis. The hydraulic control unit can further comprise a clutch piston pressure sensor, a sump fluid temperature sensor and an accumulator pressure sensor. The clutch piston pressure sensor can be coupled to the unitary hydraulic control unit housing and define a longitudinal clutch piston pressure sensor axis. The sump fluid temperature sensor can be coupled to the unitary hydraulic control unit housing and define a longitudinal sump fluid temperature sensor axis. The accumulator pressure sensor can be coupled to the unitary hydraulic control unit housing and define an accumulator pressure sensor axis. The longitudinal clutch piston pressure sensor axis, the longitudinal sump fluid temperature sensor axis and the longitudinal clutch piston pressure sensor axis are all parallel relative to each other and to the longitudinal motor axis.

According to other features, a sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. A piston can be slidably disposed in the accumulator chamber. An accumulator plug can be sealingly disposed in a second opening defined in the unitary hydraulic control unit housing at an end of the accumulator housing portion.

A hydraulic control unit that delivers hydraulic fluid to a limited slip differential constructed in accordance to additional features of the present disclosure can include a unitary hydraulic control unit housing, a motor, a clutch piston pressure sensor, a sump fluid temperature sensor and an accumulator pressure sensor. The unitary hydraulic control unit housing can include a sump housing portion, an accumulator housing portion and a housing manifold portion. The sump housing portion can define a sump chamber. The accumulator housing portion can define an accumulator chamber. The housing manifold portion can have a fluid passage that fluidly connects the sump chamber and the accumulator chamber. The motor can have an output shaft. The motor can be coupled to the unitary hydraulic control unit housing. The clutch piston pressure sensor can be coupled to the unitary hydraulic control unit housing. The clutch piston pressure sensor can define a longitudinal clutch piston pressure sensor axis. The sump fluid temperature sensor can be coupled to the unitary hydraulic housing. The sump fluid temperature sensor can define a longitudinal sump fluid temperature sensor axis. The accumulator pressure sensor can be coupled to the unitary hydraulic housing. The accumulator pressure sensor can define an accumulator pressure sensor axis. The longitudinal clutch piston pressure sensor axis, the longitudinal sump fluid temperature sensor axis and the longitudinal clutch piston pressure sensor axis are all parallel relative to each other and to the longitudinal motor axis.

According to other features, the hydraulic control unit can further comprise a sump plug, a piston and an accumulator plug. The sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. The piston can be slidably disposed in the accumulator chamber. The accumulator plug can be sealingly disposed in a second opening defined in the unitary hydraulic control unit housing at an end of the accumulator housing portion. The unitary hydraulic control unit housing can define a second snap ring groove at the second opening configured to receive a second snap ring that captures the accumulator plug in the accumulator housing portion.

A hydraulic control unit that delivers hydraulic fluid to a limited slip differential according to the present disclosure can include a unitary hydraulic control unit housing. The unitary hydraulic control unit housing can include a sump housing portion, an accumulator housing portion and a housing manifold portion. The pump housing portion can define a sump chamber. The accumulator housing portion can define an accumulator chamber. The housing manifold portion can have a fluid passage that fluidly connects the sump chamber and the accumulator chamber.

According to additional features, the sump chamber can define a longitudinal sump chamber axis. The accumulator chamber can define a longitudinal accumulator chamber axis. The longitudinal sump chamber axis and the longitudinal accumulator chamber axis can be parallel. A clutch piston pressure sensor can be coupled to the unitary hydraulic control unit housing. The clutch piston pressure sensor can be configured to measure a clutch piston pressure of the limited slip differential. A sump fluid temperature sensor can be coupled to the unitary hydraulic control unit housing. The sump fluid temperature sensor can be configured to measure a temperature of fluid in the sump chamber.

According to further features, an accumulator pressure sensor can be coupled to the unitary hydraulic control unit housing. The accumulator pressure sensor can be configured to measure a pressure in the accumulator chamber. A three-way proportional regulating valve can be coupled to the unitary hydraulic control unit housing. The three-way proportional regulating valve can be configured to regulate fluid pressure within the unitary hydraulic control unit housing.

According to still additional features the hydraulic control unit can further comprise a motor and a gerotor gear assembly. The motor can have an output shaft. The motor can be coupled to the unitary hydraulic control unit housing. The gerotor gear assembly can include an inner gerotor gear and an outer gerotor gear. The inner gerotor gear can be coupled for rotation with the output shaft. The motor can define a longitudinal motor axis. The longitudinal motor axis can be parallel to the longitudinal accumulator axis.

According to other features the longitudinal clutch piston pressure sensor axis, the longitudinal sump fluid temperature sensor axis and the longitudinal clutch piston pressure sensor axis are all parallel relative to each other and to the longitudinal motor axis. A sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. A piston can be slidably disposed in the accumulator chamber. An accumulator plug can be sealingly disposed in a second opening defined in the unitary hydraulic control unit housing at an end of the accumulator housing portion. The unitary hydraulic control unit housing can define a second snap ring groove at the second opening configured to receive a second snap ring that captures the accumulator plug in the accumulator housing portion.

A hydraulic control unit that delivers hydraulic fluid to a limited slip differential constructed in accordance to additional features can include a unitary hydraulic control unit housing, a motor and a gerotor gear assembly. The unitary hydraulic control unit housing can include a sump housing portion, an accumulator housing portion and a housing manifold portion. The sump housing portion can define a sump chamber. The accumulator housing portion can define an accumulator chamber. The housing manifold portion can have a fluid passage that fluidly connects the sump chamber and the accumulator chamber. The motor can have an output shaft. The motor can be coupled to the unitary hydraulic control unit housing. The gerotor gear assembly can include an inner gerotor gear and an outer gerotor gear. The inner gerotor gear can be coupled for rotation with the output shaft.

According to additional features, the motor can define a longitudinal motor axis. The longitudinal motor axis can be parallel to the longitudinal accumulator axis. The hydraulic control unit can further comprise a clutch piston pressure sensor, a sump fluid temperature sensor and an accumulator pressure sensor. The clutch piston pressure sensor can be coupled to the unitary hydraulic control unit housing and define a longitudinal clutch piston pressure sensor axis. The sump fluid temperature sensor can be coupled to the unitary hydraulic control unit housing and define a longitudinal sump fluid temperature sensor axis. The accumulator pressure sensor can be coupled to the unitary hydraulic control unit housing and define an accumulator pressure sensor axis. The longitudinal clutch piston pressure sensor axis, the longitudinal sump fluid temperature sensor axis and the longitudinal clutch piston pressure sensor axis are all parallel relative to each other and to the longitudinal motor axis.

According to other features, a sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. A piston can be slidably disposed in the accumulator chamber. An accumulator plug can be sealingly disposed in a second opening defined in the unitary hydraulic control unit housing at an end of the accumulator housing portion.

A hydraulic control unit that delivers hydraulic fluid to a limited slip differential constructed in accordance to additional features of the present disclosure can include a unitary hydraulic control unit housing, a motor, a clutch piston pressure sensor, a sump fluid temperature sensor and an accumulator pressure sensor. The unitary hydraulic control unit housing can include a sump housing portion, an accumulator housing portion and a housing manifold portion. The sump housing portion can define a sump chamber. The accumulator housing portion can define an accumulator chamber. The housing manifold portion can have a fluid passage that fluidly connects the sump chamber and the accumulator chamber. The motor can have an output shaft. The motor can be coupled to the unitary hydraulic control unit housing. The clutch piston pressure sensor can be coupled to the unitary hydraulic control unit housing. The clutch piston pressure sensor can define a longitudinal clutch piston pressure sensor axis. The sump fluid temperature sensor can be coupled to the unitary hydraulic housing. The sump fluid temperature sensor can define a longitudinal sump fluid temperature sensor axis. The accumulator pressure sensor can be coupled to the unitary hydraulic housing. The accumulator pressure sensor can define an accumulator pressure sensor axis. The longitudinal clutch piston pressure sensor axis, the longitudinal sump fluid temperature sensor axis and the longitudinal clutch piston pressure sensor axis are all parallel relative to each other and to the longitudinal motor axis.

According to other features, the hydraulic control unit can further comprise a sump plug, a piston and an accumulator plug. The sump plug can be sealingly disposed in a first opening defined in the unitary hydraulic control unit housing at an end of the sump housing portion. The unitary hydraulic control unit housing can define a first snap ring groove at the first opening configured to receive a snap ring that captures the sump plug in the sump housing portion. The piston can be slidably disposed in the accumulator chamber. The accumulator plug can be sealingly disposed in a second opening defined in the unitary hydraulic control unit housing at an end of the accumulator housing portion. The unitary hydraulic control unit housing can define a second snap ring groove at the second opening configured to receive a second snap ring that captures the accumulator plug in the accumulator housing portion.

### BRIEF DESCRIPTION OF THE DRAWINGS

The present disclosure will become more fully understood from the detailed description and the accompanying drawings, wherein:

FIG. 1 is a front perspective view of a hydraulic control unit constructed in accordance to one example of the present disclosure;

FIG. 2 is a top perspective view of the hydraulic control unit of FIG. 1;

FIG. 3A is a plan view of a hydraulic control unit housing mounting surface;

FIG. 3B is a plan view of the hydraulic control unit housing mounting surface and shown with a fluid filter and fluid filter cap shown in exploded view;

FIG. 4 is a front perspective view of a motor mounting plate of the hydraulic control unit of FIG. 1;

FIG. 5 is a plan view of an interface plate and gerotor gear assembly of the hydraulic control unit of FIG. 1;

FIG. 6 is a side perspective view of the hydraulic control unit of FIG. 1;

FIG. 7 is an exploded perspective view of the hydraulic control unit of FIG. 6;

FIG. 8 is a cross-sectional view of the hydraulic control unit of FIG. 2 taken along lines 8-8;

FIG. 9 is a cross-sectional view of the hydraulic control unit of FIG. 8 taken along lines 9-9; and

FIG. 10 is a cross-sectional view of the hydraulic control unit of FIG. 9 taken along lines 10-10.

### DETAILED DESCRIPTION

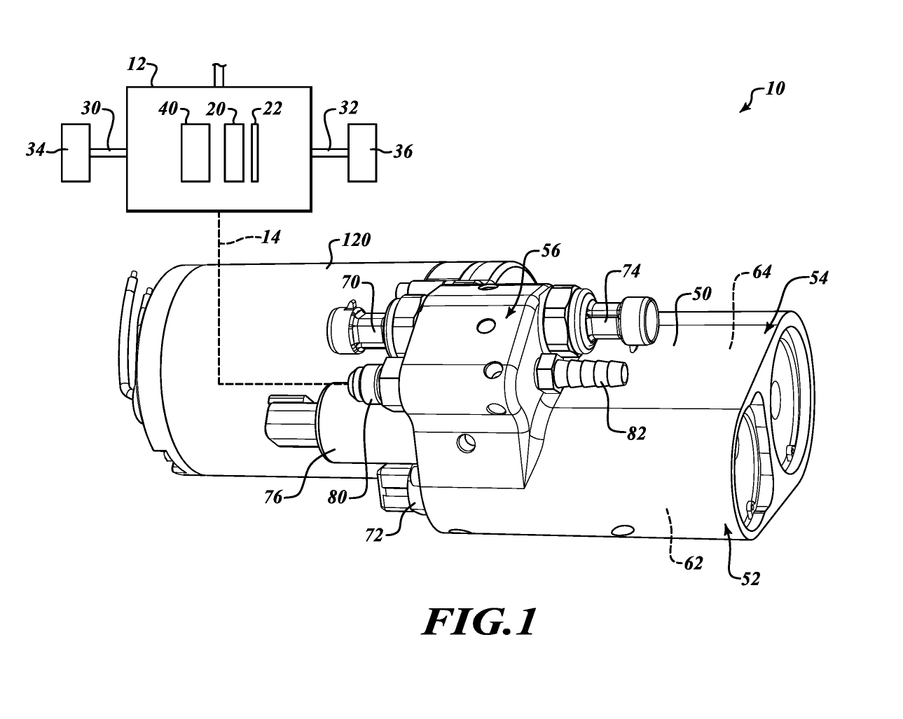

With initial reference to FIG. 1, a hydraulic control unit constructed in accordance to one example of the present disclosure is shown and generally identified with reference numeral 10. As will become appreciated herein, the hydraulic control unit 10 according to the present disclosure provides a single unit that can be mounted in one location on a vehicle. The configuration allows for simple assembly and setup. In general, the hydraulic control unit 10 can deliver hydraulic fluid to a limited slip differential 12 through a hydraulic fluid line 14. The limited slip differential 12 can be an electronic limited slip differential having a clutch 20 and a piston 22.

The limited slip differential assembly 12 can be received in a housing (not shown) and operates to drive a pair of axle shafts 30, 32 that are connected to a pair of respective drive wheels 34, 36. In general, the limited slip differential assembly 12 functions as a traditional open differential during normal operating conditions until an event occurs where a bias torque is required. When a loss in traction is detected or anticipated, the clutch 20 can be selectively actuated in order to generate the optimum bias ratio for the situation.

The limited slip differential 12 can further include a differential gear assembly 40 that acts to allow the axle shafts 30, 32 to rotate at different speeds. The differential gear assembly 40 can include a pair of side gears (not specifically shown) that are mounted for rotation with the axle shafts 30 and 32 (and the drive wheels 34 and 36). In an open configuration, described below, the differential gear assembly 40 acts to allow the axle shafts 30 and 32 to rotate at different speeds.

The clutch 20 couples a drive shaft output with the differential gear assembly 40. The clutch 20 can include a clutch pack (not specifically shown) that has a plurality of annular plates interleaved between a plurality of annular friction disks. The plurality of annular plates and annular friction disks are interleaved between one another and act to rotate past one another in substantially non-contacting relationship when the clutch 20 is in its open position. However, it will be appreciated by those skilled in the art that the term “non-contacting” as used herein is relative and is not meant to necessarily indicate that the annular plates and annular friction disks have absolutely no contact when the clutch 20 is in the open condition. The annular plates and annular friction disks are axially movable into frictional engagement relative to one another, thereby reducing relative rotation between the annular plates and annular friction disks when the clutch 20 is in the closed or partially closed configurations. In this manner, when the clutch 20 is in its closed position, the side gears, as well as the axle shafts and the drive wheels rotate together.

The clutch 20 can operate in an open configuration to allow the side gears to rotate independently from each other, e.g., at different speeds. The clutch 20 can also operate in a closed or partially closed configuration where the side gears rotate together or partially together (that is, not independently), e.g., at substantially the same speed. The clutch 20 is a hydraulic clutch that utilizes pressurized hydraulic fluid provided through the hydraulic fluid line 14 from the hydraulic control unit 10 to act on the piston 22 to selectively actuate the clutch pack between the open, closed and partially closed configurations. It will be appreciated that the limited slip differential 12 described above is merely exemplary. In this regard, the hydraulic control unit 10 can be used to deliver hydraulic fluid to an actuator (piston, etc.) of any limited slip differential configuration.

With general reference now to FIGS. 1-6, the hydraulic control unit 10 will be described in greater detail. The hydraulic control unit 10 can generally include a unitary hydraulic control unit housing 50 having a sump housing portion 52, an accumulator housing portion 54 and a housing manifold portion 56. The sump housing portion 52 can define a sump chamber 62. The accumulator housing portion 54 can define an accumulator chamber 64. The sump chamber 62 and the accumulator chamber 64 can be discrete reservoirs defined in the unitary hydraulic control unit housing 50. The housing manifold portion 56 can define various fluid passages configured to provide access to various sensors disclosed herein. The housing manifold portion 56 can also fluidly connect the sump chamber 62 and the accumulator chamber 64.

The hydraulic control unit 10 can further include a clutch piston pressure sensor 70, a sump fluid temperature sensor 72, an accumulator pressure sensor 74 and a three-way proportional regulating valve 76. The clutch piston pressure sensor 70 can be threadably or otherwise securely received by the unitary hydraulic control unit housing 50. The clutch piston pressure sensor 70 can be configured to measure a pressure at the piston 22 of the limited slip differential 12. The sump fluid temperature sensor 72 can be threadably or otherwise securely received by the unitary hydraulic control unit housing 50. The sump fluid temperature sensor 72 can be configured to measure a temperature of fluid in the sump chamber 62. The accumulator pressure sensor 74 can be threadably or otherwise securely received by the unitary hydraulic control unit housing 50. The accumulator pressure sensor 74 can be configured to measure a pressure in the accumulator chamber 64.

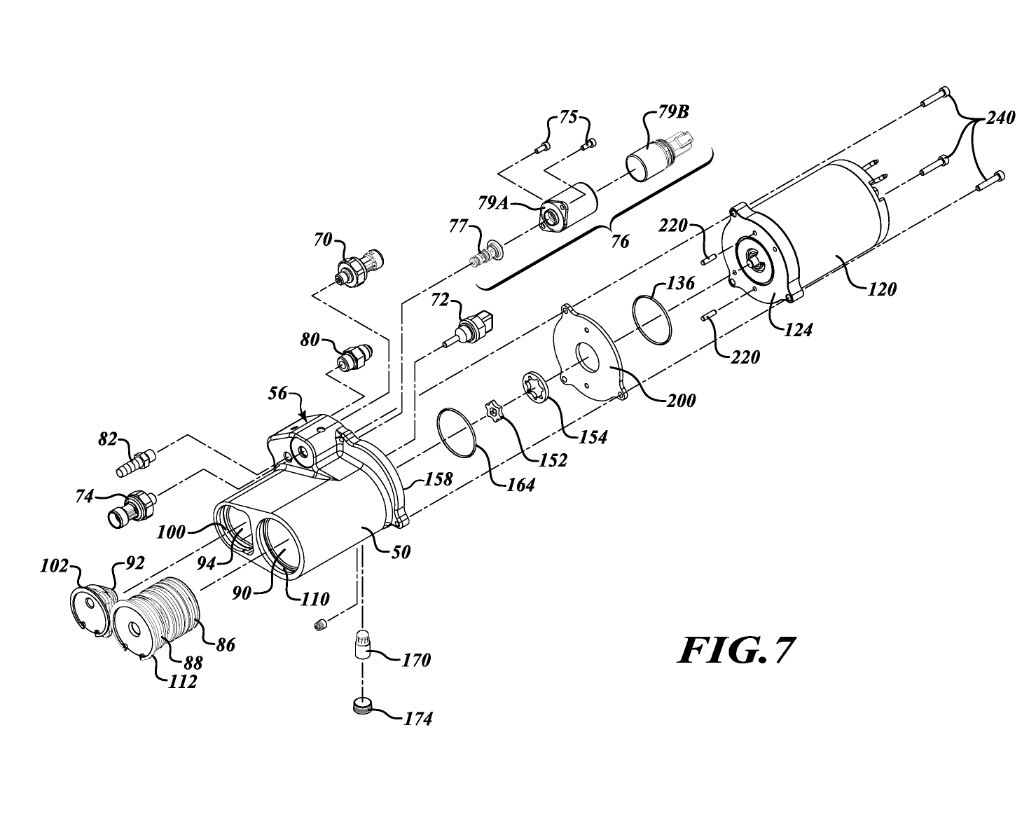

The three-way proportional regulating valve 76 can be threadably or otherwise securely received by the unitary hydraulic control unit housing 50. In the example show, the three-way proportional regulating valve 76 is secured to the unitary hydraulic control unit housing 50 by fasteners 75. The three-way proportional regulating valve 76 can include a valve portion 77 (FIG. 7), an outer housing portion 79A and an inner housing portion 79B. The three-way proportional regulating valve 76 can be configured to regulate fluid pressure within the unitary hydraulic control unit housing 50.

A hydraulic fluid line connector 80 can be threadably or otherwise secured to the hydraulic control unit housing 50. The hydraulic fluid line connector 80 can fluidly connect the hydraulic fluid line 14 to the hydraulic control unit housing 50. A sump vent line connector 82 can be threadably or otherwise secured to the hydraulic control unit housing 50. The sump vent line connector 82 can couple with a hose (not shown) to vent the sump chamber 62 to atmosphere.

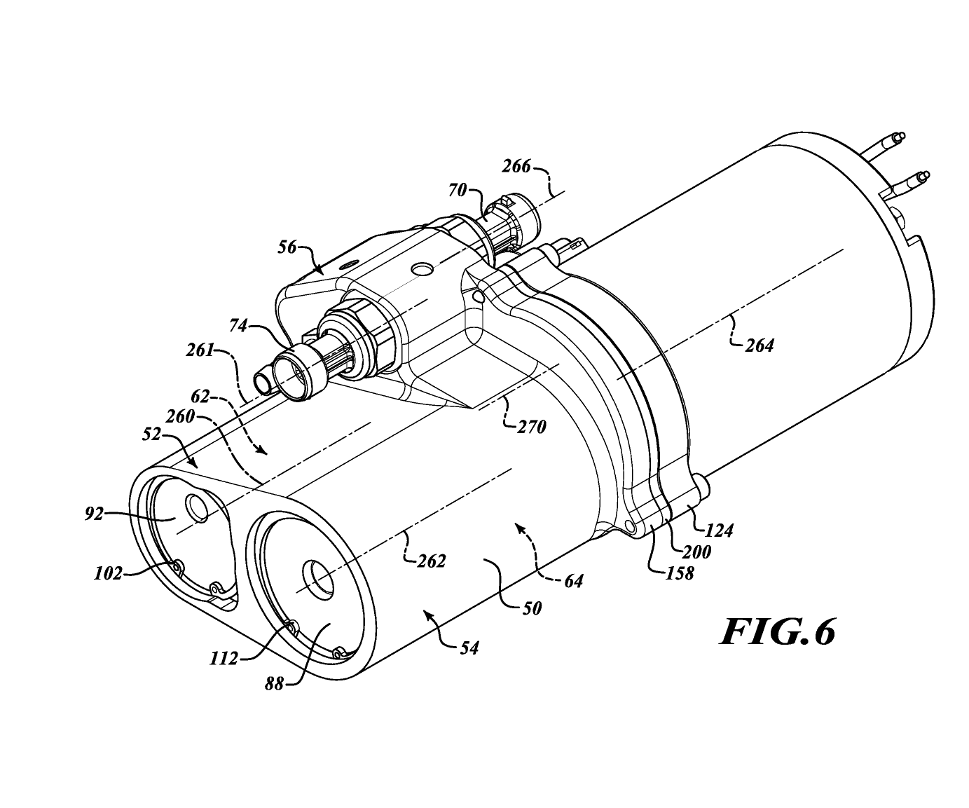

With particular reference now to FIGS. 6 and 7, additional features of the hydraulic control unit 10 will be described. An accumulator piston 86 can be slidably disposed in the accumulator chamber 64. An accumulator plug 88 can be sealingly disposed in an opening 90 defined in the unitary hydraulic control unit housing 50 at an end of the accumulator housing portion 54. A sump plug 92 can be sealingly disposed in an opening 94 defined in the unitary hydraulic control unit housing 50 at an end of the sump housing portion 52. A first snap ring groove 100 can be defined in the hydraulic control unit housing 50 at the opening 94. The first snap ring groove 100 can be configured to receive a first snap ring 102 that captures the sump plug 92 in the sump chamber 62 of the sump housing portion 52. A second snap ring groove 110 can be defined in the hydraulic control unit housing 50 at the opening 90. The second snap ring groove 110 can be configured to receive a second snap ring 112 that captures the accumulator plug 88 in the accumulator chamber 64 of the accumulator housing portion 54.

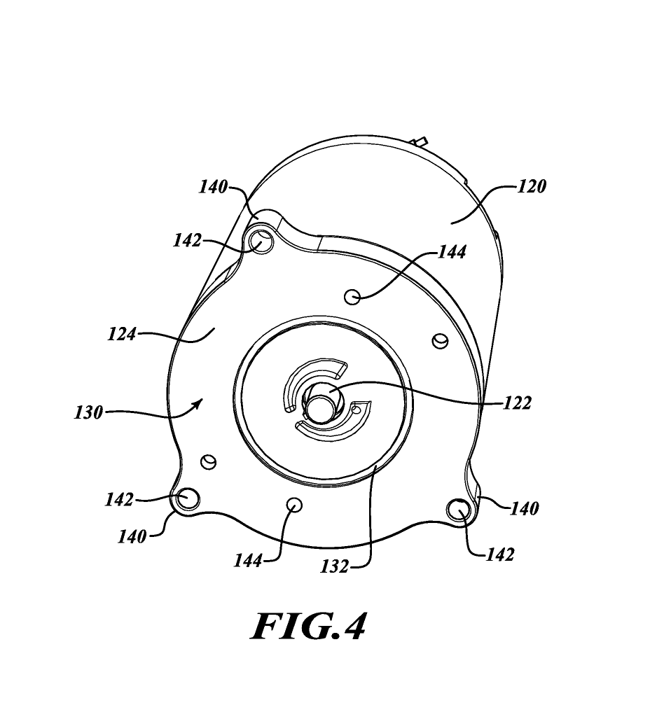

With general reference again to FIGS. 1-7, additional features of the hydraulic control unit 10 will be described. A motor 120 can be coupled to the hydraulic control unit housing 50. The motor 120 can have an output shaft 122 (FIG. 4) and a motor mounting plate 124. The motor mounting plate 124 can have a motor mounting surface 130. The motor mounting plate 124 can define a radial groove 132 at a location radially outwardly of the output shaft 122. The radial groove 132 can receive an o-ring 136 (FIG. 7). The motor mounting plate 124 can include a plurality of radially extending motor mounting ears 140 (FIG. 4) that define a corresponding plurality of motor mounting apertures 142. A pair of locating post apertures 144 are defined in the motor mounting plate 124.

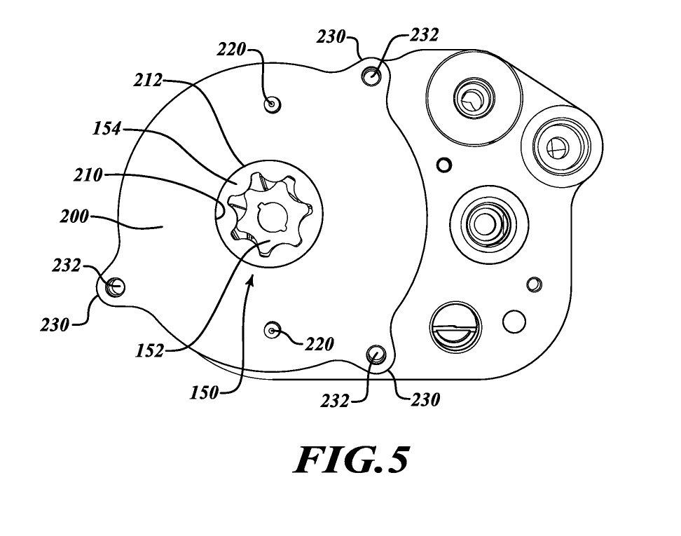

The motor 120 can operate a gerotor gear assembly 150 (FIG. 5). The gerotor gear assembly 150 can be conventionally constructed and can generally comprise an inner gerotor gear 152 and an outer gerotor gear 154. The inner gerotor gear 152 is coupled for rotation with the output shaft 122. The operation of the gerotor gear assembly 150 can be conventional where relative rotation of the inner and outer gerotor gears 152 and 154 can cause a pumping action on the fluid contained in the hydraulic control unit housing 50 ultimately causing the fluid to be pumped to the limited slip differential 12 through the hydraulic fluid line 14.

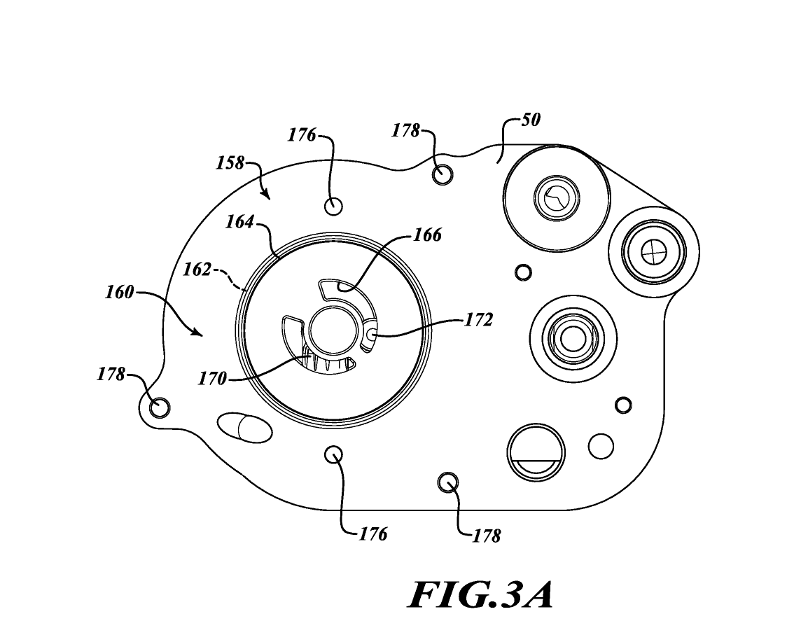

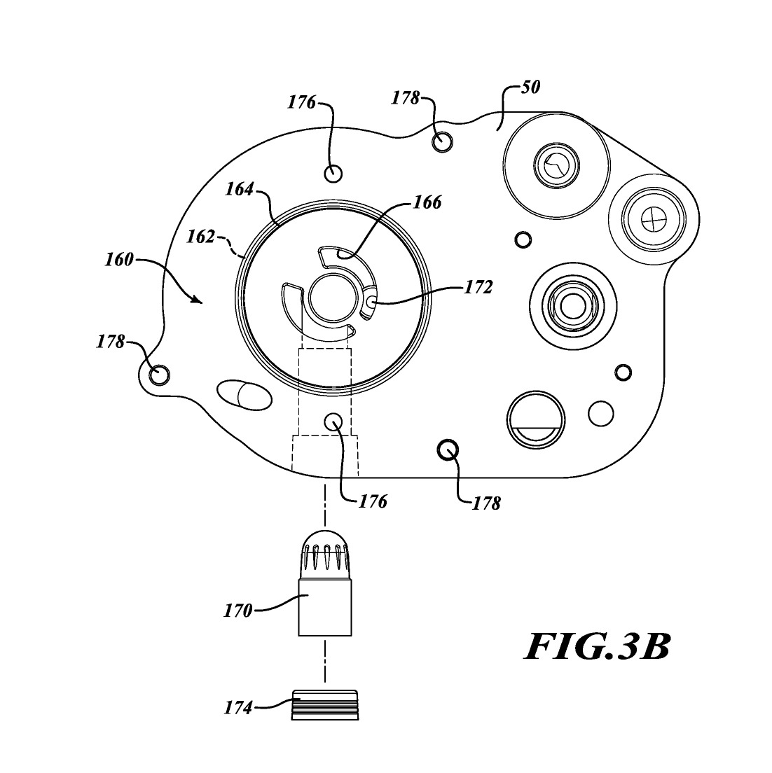

With specific reference now to FIGS. 3A and 3B, additional features of the hydraulic control unit housing 50 will be described. The hydraulic control unit housing 50 can include a hydraulic control unit housing mounting structure 158 having a hydraulic control unit housing surface 160 that defines a radial groove 162. The radial groove 162 can be configured to receive an o-ring 164. A pump inlet port 166 can be defined through the hydraulic control unit housing 50. A fluid filter 170 and fluid check valve 172 can be disposed in the hydraulic control unit housing 50. The fluid filter 170 can filter hydraulic fluid ultimately flowing between the hydraulic control unit 10 and the limited slip differential 12. A filter plug 174 can capture the fluid filter 170 within the hydraulic control unit housing 50. The fluid check valve 172 can restrict backflow of fluid. A pair of locating post apertures 176 can be defined in the hydraulic control unit housing 150. A plurality of housing mounting apertures 178 can be defined in the hydraulic control unit housing 150.

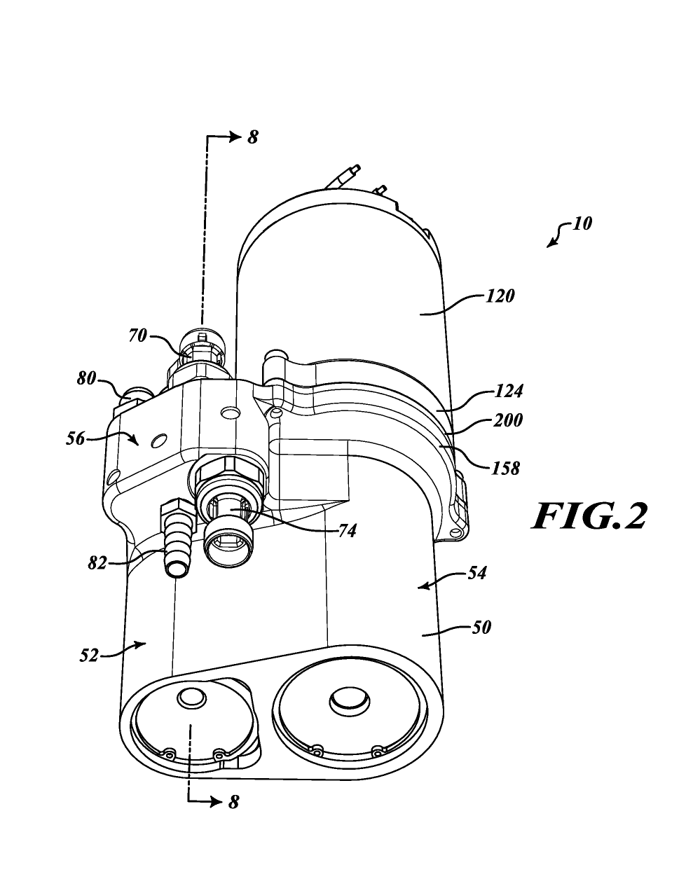

An interface plate 200 (FIGS. 2 and 5-7) can be mounted between the hydraulic control unit housing 50 and the motor 120. More specifically, the interface plate 120 can be mounted for contact between the housing mounting surface 160 (FIG. 3A) and the motor mounting surface 130 (FIG. 4). The interface plate 200 can have an inner diameter 210 (FIG. 5) that defines an opening 212. A pair of locating posts 220 can be received through a corresponding pair of locating post apertures 224 defined through the interface plate 200. In an assembled position, the locating posts 220 can be received by the locating post apertures 144 (FIG. 4) on the motor mounting plate 124 and the locating post apertures 176 (FIG. 3A) defined in the hydraulic control unit housing 50. The locating posts 220 can inhibit relative rotation between the motor 120, the interface plate 200 and the hydraulic control unit housing 50.

The interface plate 200 can include a plurality of radially extending plate mounting ears 230 that define a corresponding plurality of interface plate mounting apertures 232. In an assembled position, the plurality of interface plate mounting apertures 232 (FIG. 5), the plurality of motor mounting apertures 142 (FIG. 4) and the plurality of housing mounting apertures 178 (FIG. 3A) cooperatively align to receive a plurality of fasteners 240 (FIG. 7).

With reference now to FIG. 5, the outer gerotor gear 154 is received by the opening 212 in the interface plate 200. In the example provided, the outer gerotor gear 154 is received by the opening 212 in an interference fit. According to the present teachings, the interface plate 200 is formed of a material having a coefficient of expansion that is equal or at least substantially similar to the outer gerotor gear 154. In one example, the interface plate 200 and the outer gerotor gear 154 are both formed of steel. In another example, the interface plate 200 and the outer gerotor gear 154 are both formed of powdered metal. By incorporating an interface plate 200 having a similar or common coefficient of expansion as the outer gerotor gear 154, axial contraction of the interface plate at the opening 212 can be consistent with axial expansion of the outer gerotor gear 154. In this regard, pump efficiency can be maintained. In other prior art configurations, such as pump interfaces formed of aluminum, the gerotor gear assembly 150 can become inoperable or operate inefficiently such as when the eccentric ring or pump pocket (opening 212) contracts axially during low temperature conditions inhibiting sufficient clearance for the inner and outer gerotor gears to operate.

With particular reference now to FIG. 6, additional features of the hydraulic control unit 10 will be described. As identified above, the hydraulic control unit allows for a single unit having a unitary housing with discrete reservoirs. The overall packaging optimizes performance while maintaining a relatively small required area for mounting. In general, the components of the hydraulic control unit 10 are all arranged in a parallel relationship to contribute to the reduced size. Specifically, the sump chamber 62 defines a longitudinal sump chamber axis 260. The accumulator chamber 64 defines a longitudinal accumulator chamber axis 261. The motor 120 defines a longitudinal motor axis 264. The clutch piston pressure sensor 70 defines a longitudinal clutch piston pressure sensor axis 266. The accumulator pressure sensor 74 defines a longitudinal accumulator pressure sensor axis 268. The sump fluid temperature sensor 72 defines a longitudinal sump fluid temperature sensor axis 270. All of the longitudinal axes 260, 262, 264, 266, 268 and 270 are parallel to each other. Such a relationship contributes to the compact package of the hydraulic control unit 10 that can be conveniently mounted onto a vehicle such as onto a vehicle chassis. In this regard, a separate accumulator and pump requiring separate mounting points can be avoided.

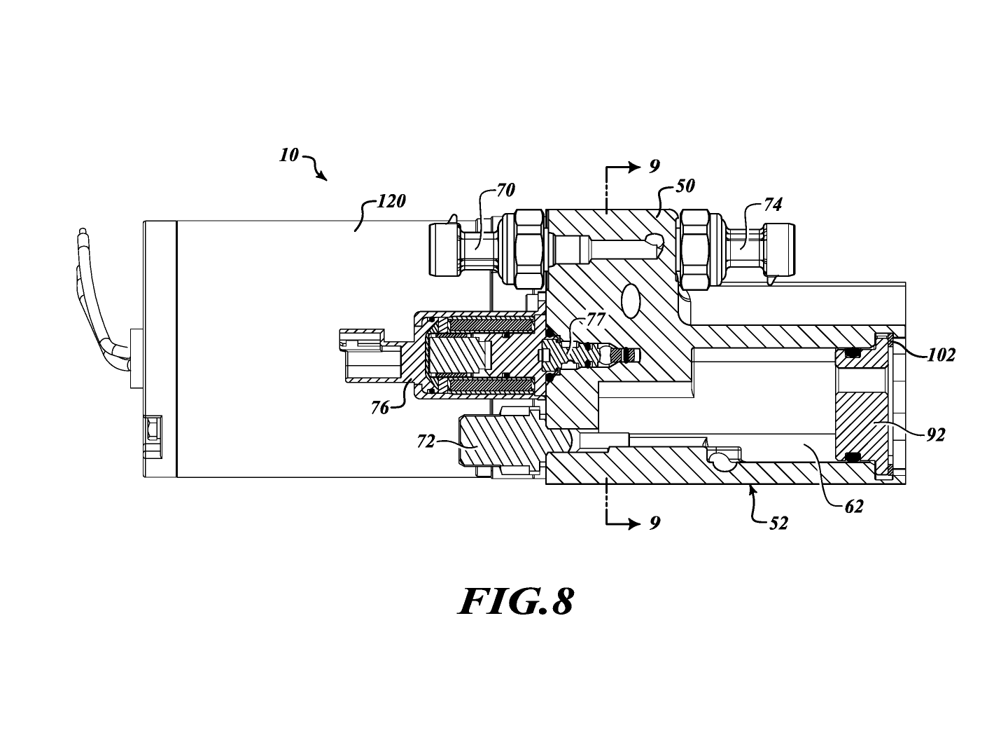

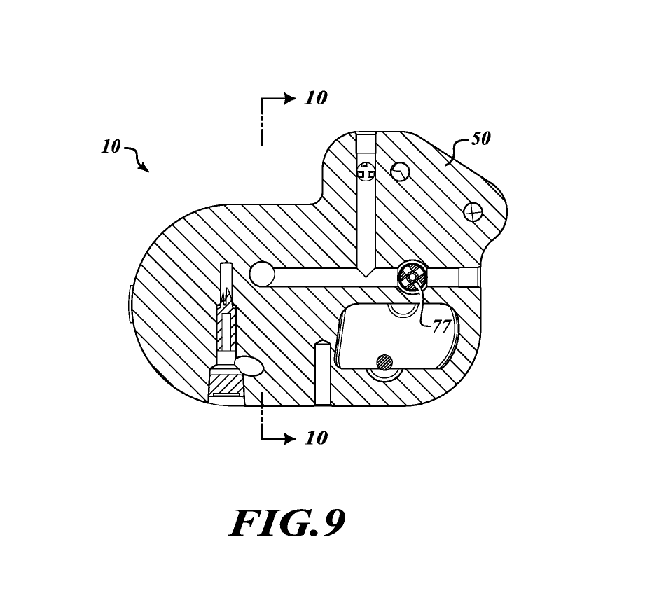

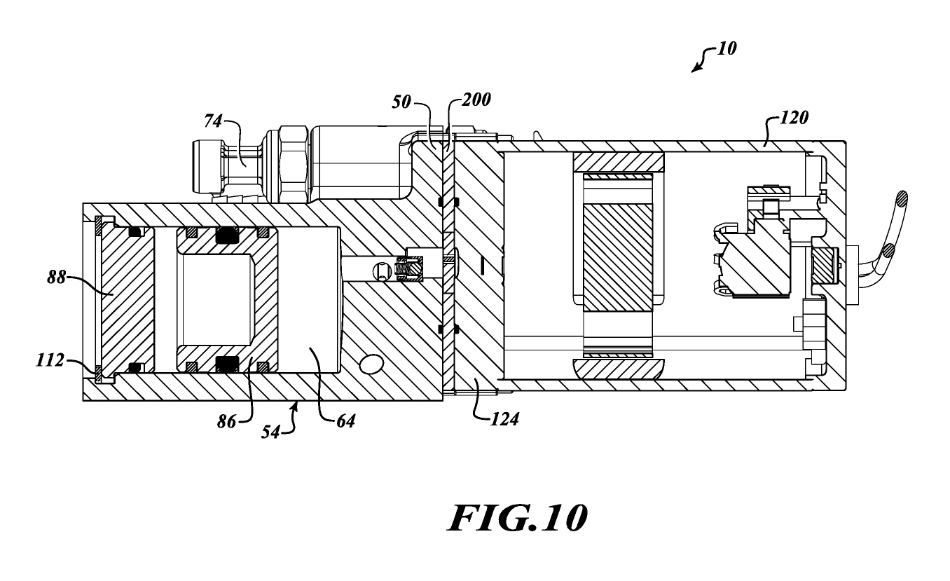

FIGS. 8-10 shows various cross-sections of the hydraulic control unit 10. FIG. 8 illustrates the sump fluid temperature sensor 72 communicating with the sump chamber 62. FIG. 10 shows the interface plate 200 in cross-section mounted between the motor 120 and the unitary hydraulic control unit housing 50.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A hydraulic control unit that delivers hydraulic fluid to a limited slip differential, the hydraulic control unit comprising:
a hydraulic control unit housing having a housing mounting surface, the housing mounting surface defining a fluid inlet port therein;
a motor having an output shaft and a motor mounting plate that has a motor mounting surface;
a gerotor gear assembly including an inner gerotor gear and an outer gerotor gear, wherein the outer gerotor gear is formed of a first material having a first coefficient of expansion, the inner gerotor gear coupled for rotation with the output shaft; and
an interface plate mounted between the housing mounting surface and the motor mounting surface, the interface plate having an inner diameter that defines an opening that receives the outer gerotor gear in an interference fit, wherein the interface plate is formed of a second material having a second coefficient of expansion and wherein the first and second coefficients of expansion are substantially equivalent.

2. The hydraulic control unit of claim 1 wherein the interface plate and the outer gerotor gear are formed of the same material.

3. The hydraulic control unit of claim 1 wherein the interface plate is formed of steel.

4. The hydraulic control unit of claim 3 wherein the outer gerotor gear is formed of steel.

5. The hydraulic control unit of claim 1 wherein the interface plate is formed of powdered metal.

6. The hydraulic control unit of claim 5 wherein the outer gerotor gear is formed of powdered metal.

7. The hydraulic control unit of claim 1 wherein the interface plate has a plurality of radially extending plate mounting ears that define a corresponding plurality of plate mounting apertures.

8. The hydraulic control unit of claim 7 wherein the motor mounting plate has a plurality of radially extending motor mounting apertures.

9. The hydraulic control unit of claim 8 wherein the hydraulic control unit housing defines a plurality of housing mounting apertures and wherein (i) the plurality of interface plate mounting apertures, (ii) the plurality of motor mounting apertures and (iii) the plurality of housing mounting apertures cooperatively align to receive a plurality of fasteners that secure the motor, interface plate and the hydraulic control unit housing together.

10. The hydraulic control unit of claim 1 wherein the hydraulic control unit housing further comprises an integrally formed housing manifold portion that defines a fluid port configured to at least partially communicate hydraulic fluid between the accumulator housing portion and the limited slip differential.

11. The hydraulic control unit of claim 1, further comprising a pair of locating posts, wherein the hydraulic control unit housing defines a first pair of locating post apertures, the interface plate defines a second pair of locating post apertures and the motor mounting plate defines a third pair of locating post apertures, the pair of locating posts received by the first, second and third locating post apertures to inhibit relative rotation of the hydraulic control unit housing, interface plate and motor.

12. The hydraulic control unit of claim 1 wherein the motor mounting plate defines a radial groove at a location radially outwardly of the output shaft, the radial groove receiving an o-ring that sealingly engages the interface plate.

13. The hydraulic control unit of claim 1 wherein the hydraulic control unit housing is unitary and further comprises an accumulator housing portion and a sump housing portion.

14. A hydraulic control unit that delivers hydraulic fluid to a limited slip differential, the hydraulic control unit comprising:
a hydraulic control unit housing having a housing mounting surface;
a motor having an output shaft and a motor mounting plate that has a motor mounting surface;
a gerotor gear assembly including an inner gerotor gear and an outer gerotor gear, wherein the outer gerotor gear is formed of steel, and wherein the inner gerotor gear is coupled for rotation with the output shaft; and
an interface plate mounted between the housing mounting surface and the motor mounting surface, the interface plate engaged to the outer gerotor gear in fixed relationship, wherein the interface plate is formed of steel, wherein the steel outer gerotor gear and the steel interface plate are configured to thermally expand at a substantially similar rate.

15. The hydraulic control unit of claim 14 wherein the interface plate has an inner diameter that defines an opening that receives the outer gerotor gear in an interference fit.

16. The hydraulic control unit of claim 15 wherein the outer gerotor gear and the interface plate are formed of powdered metal.

17. The hydraulic control unit of claim 14 wherein the interface plate has a plurality of radially extending plate mounting ears that define a corresponding plurality of plate mounting apertures, the motor mounting plate has a plurality of radially extending motor mounting apertures and the hydraulic control unit housing defines a plurality of housing mounting apertures and wherein (i) the plurality of interface plate mounting apertures, (ii) the plurality of motor mounting apertures and (iii) the plurality of housing mounting apertures cooperatively align to receive a plurality of fasteners that secure the motor, interface plate and the hydraulic control unit housing together.

18. A hydraulic control unit that delivers hydraulic fluid to a limited slip differential, the hydraulic control unit comprising:
a hydraulic control unit housing having a housing mounting surface;
a motor having an output shaft and a motor mounting plate that has a motor mounting surface;
a gerotor gear assembly including an inner gerotor gear and an outer gerotor gear, wherein the outer gerotor gear is formed of powdered metal, and wherein the inner gerotor gear is coupled for rotation with the output shaft; and
an interface plate mounted between the housing mounting surface and the motor mounting surface, the interface plate engaged to the outer gerotor gear in fixed relationship, wherein the interface plate is formed of powdered metal, wherein the powdered metal outer gerotor gear and the powdered metal interface plate are configured to thermally expand at a substantially similar rate.

19. The hydraulic control unit of claim 18 wherein the outer gerotor gear and the interface plate are formed of steel.

20. The hydraulic control unit of claim 18 wherein the interface plate has a plurality of radially extending plate mounting ears that define a corresponding plurality of plate mounting apertures, the motor mounting plate has a plurality of radially extending motor mounting apertures and the hydraulic control unit housing defines a plurality of housing mounting apertures and wherein (i) the plurality of interface plate mounting apertures, (ii) the plurality of motor mounting apertures and (iii) the plurality of housing mounting apertures cooperatively align to receive a plurality of fasteners that secure the motor, interface plate and the hydraulic control unit housing together.
